(19) United States
(12) Patent Application Publication
(10) Pub. No.: US 2004/0140443 A1
(43) Pub. Date: Jul. 22, 2004

(54) Hydraulic control apparatus

(75) Inventors: Hideki Miyata, Okazaki-shi (JP); Masafumi Kinoshita, Toyota-shi (JP); Yuji Yasuda, Nishikamo-gun (JP); Masaru Morise, Toyota-shi (JP); Akio Sugawara, Toyota-shi (JP); Fuminori Suzuki, Okazaki-shi (JP); Naoyuki Fukaya, Okazaki-shi (JP); Haruki Yamamoto, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyota Jidosha Kabushiki Kaisha, Toyota-shi (JP)

(21) Appl. No.: 10/692,783

(22) Filed: Oct. 27, 2003

(30) Foreign Application Priority Data
Oct. 28, 2002 (JP) 2002-313382

(51) Int. Cl. F16K 31/02

(52) U.S. Cl. 251/129.15; 251/291

(57) ABSTRACT

In a hydraulic control apparatus, a valve accommodation hole of a valve body also serves as a sleeve, and a spool is fitted in the valve accommodation hole. Therefore, the size of the valve accommodation hole is reduced by an amount corresponding to the thickness of the sleeve, thus reducing the weight and size of the hydraulic control apparatus. Also, a solenoid portion is detachably fixed to the valve body with a snap-fastener. Accordingly, in the case of a failure of the solenoid valve, only one of the solenoid portion and the spool can be easily replaced depending upon the type of the failure by canceling fixation with the snap-fastener.

The disclose of Japanese Patent Application No. 2002-313382 filed on Oct. 28, 2002 including the specification, drawings and abstract is in incorporation herein by reference in its entirety.

### BACKGROUND OF THE INVENTION

1. Field of the Invention

The invention relates to a hydraulic control apparatus, and more particularly to a hydraulic control apparatus in which a solenoid valve is fixedly disposed in a valve body.

2. Description of the Related Art

A hydraulic control apparatus is widely known which includes a solenoid valve provided with a valve portion having a spool, and a solenoid portion urging the spool in the axial direction by using electromagnetic force, and a valve body in which a valve accommodation hole is provided. The solenoid valve is fixedly mounted on the valve body such that the valve portion is received in the valve accommodation hole. A device as disclosed in Japanese Patent Application Laid-Open No. 5-231523 ([0009] to [0013], see the FIG. 1) is an example of the hydraulic control apparatus which is intended for use in an automatic transmission. The valve portion has a sleeve in which the spool is slidably engaged. In addition, the sleeve is fixed to the solenoid portion and inserted into the valve accommodation hole, to be fixedly mounted in the valve body.

However, in the hydraulic control apparatus as described above, it is necessary to provide the valve accommodation hole having a size suitable for receiving the sleeve, thus requiring a large size of the valve body and limiting reductions of the size and weight of the hydraulic control apparatus. Also, because the valve portion of the solenoid valve and the solenoid portion are constructed as a unit, the whole solenoid valve needs to be replaced by a new one when a failure or the like occurs. This causes disadvantages in terms of cost and effective use of resources.

### SUMMARY OF THE INVENTION

It is an object of the invention to provide a hydraulic control apparatus constructed with reduced weight and size, which makes effective use of a solenoid portion and a valve portion depending upon the type of a failure of a solenoid valve.

A hydraulic control apparatus according to a first aspect of the invention includes a solenoid valve and a valve body. The solenoid valve includes a valve portion having a spool, and a solenoid portion adapted to urge the spool in an axial direction by using electromagnetic force. The valve body having a valve accommodation hole. The solenoid valve is arranged with respect to the valve body such that the valve portion is received in the valve accommodation hole. Further, the hydraulic control apparatus includes a fixing member, which fixes the solenoid valve to the valve body. In the hydraulic control apparatus the spool is formed so as to slidably fit in the valve accommodation hole. The solenoid portion is disposed at an open end of the valve accommodation hole, and the solenoid portion is fixed to the valve body by fixing member. Thus, the valve accommodation hole of the valve body also serves as the sleeve of the valve body, and the spool is fitted in the valve accommodation hole. Therefore, the size of the valve accommodation hole is reduced by an amount corresponding to the thickness of the sleeve, resulting in reductions in the weight and size of the valve body and the hydraulic control apparatus.

In the first aspect of the invention, the solenoid portion may include a plunger formed separately from the spool, and urges the spool by using the plunger; and the fixing member detachably fixes the solenoid portion to the valve body. Thus, the solenoid portion of the solenoid valve and the spool are independently mounted in the valve body, and the solenoid portion is detachably fixed to the valve body with the fixing device. Therefore, in the case of a failure of the solenoid valve, only one of the solenoid portion and the spool can be easily replaced depending upon the type of the failure by canceling fixation with the fixing device, which enables the effective use of usable resources and reduces a cost of parts.

In the first aspect of the invention, the hydraulic control apparatus may further include a fitting projecting portion provided in one of the solenoid portion and the valve body; and a fitting recessed portion provided in the other of the solenoid portion and the valve body, and the fitting projecting portion and the fitting recessed portion engage with each other such that the solenoid portion and the valve accommodation hole are positioned concentrically with each other. Thus, the fitting projecting portion and the fitting recessed portion that engage with each other are provided in one of the solenoid portion and the valve body, and the other, respectively, and the solenoid portion and the valve accommodation hole, i.e., the spool, are concentrically positioned. Therefore, the solenoid portion can be easily fixed to the valve body with a high accuracy. In addition, variations in the quality (controlling accuracy and the like) of the solenoid valve are reduced, thus assuring high quality.

In the above aspect of the invention, the fitting projecting portion having an annular shape may be provided concentrically in the opening portion of the valve accommodation hole, and be fitted in the fitting recessed portion having an annular shape and provided concentrically in an end portion of the solenoid portion, so as to position the valve accommodation hole and the solenoid portion concentrically with each other. In addition, the spool includes a positioning large-diameter portion that is located radially inwardly of a fitting portion of the fitting projecting portion and the fitting recessed portion, and the positioning large-diameter portion is slidably fitted in the valve accommodation hole, and is positioned concentrically with the valve accommodation hole. Thus, the fitting projecting portion is provided in the opening portion of the valve accommodation hole, and is fitted in the fitting recessed portion provided in the end portion of the solenoid portion, whereby both are concentrically provided. In addition, the spool is provided with the positioning large-diameter portion that is located radially inwardly of the fitting portion of the fitting projecting portion and the fitting recessed portion. With the positioning large-diameter portion slidably fitted in the valve accommodation hole, the spool and the solenoid portion are positioned concentrically with each other with high accuracy, thus assuring further improved quality of the solenoid valve.

In the above aspect of the invention, the positioning large-diameter portion may be slidably fitted in the vicinity of the opening portion of the valve accommodation hole so as to position the spool concentrically with the valve accommodation hole at a position that is the close to the solenoid portion.

In the first aspect of the invention, the fitting projecting portion may be press-fitted in the fitting recessed portion so that the solenoid portion is fixed to the valve body.

In the first aspect of the invention, the valve body has a part accommodation hole may be formed separately from the valve accommodation hole, the part accommodation hole receives an assembly part; and the solenoid portion is formed integrally with a flange that engages with the assembly part thereby to prevent the assembly part from being detached from the part accommodation hole. Thus, in the case where the part accommodation hole is provided in the valve body and the assembly part is disposed in the hole, the assembly part is held in the valve accommodation hole with the flange provided on the solenoid portion of the solenoid valve. Therefore, assembling is conducted easily compared to the case where the assembly part is fixed independently of the solenoid portion. In addition, a space for fixing is not required, and the solenoid valve and the assembly part can be located close to each other, resulting in a reduction in the size of the hydraulic control.

In the first aspect of the invention, the valve accommodation hole provided in the valve body may be closed at one end thereof remote from the opening portion in which the solenoid portion is provided, and a bottom of the valve accommodation hole at the one end is provided by a male screw received in the valve body.

In the first aspect of the invention, a diameter of the spool may constant, or decreases toward the solenoid portion.

In the first aspect of the invention, the fixing member may comprise a snap-fastener including a body-side engaging portion that engages with the valve body, a solenid-side engaging portion that engages with the solenoid portion, and an elastic deformable portion provided between the solenoid-side engaging portion and the body-side engaging portion, the elastic deformable portion being elastically deformed while the fixing member is mounted in place in the valve body; and the snap-fastener presses the solenoid portion against the valve body by using elasticity of the elastically deformable portion. Thus, the snap-fastener is used as the fixing device for fixing the solenoid portion to the valve body, and the solenoid potion can be easily and quickly mounted on the valve body or replaced by a new one.

In the first aspect of the invention, the fixing member may comprise a threaded fastening member that detachably fixes the solenoid portion to the valve body.

A hydraulic control apparatus according to a second aspect of the invention includes a solenoid valve and a valve body. The solenoid valve includes a valve portion having a spool, and a solenoid portion adapted to urge the spool in an axial direction by using electromagnetic force. The valve body having a valve accommodation hole. The solenoid valve is arranged with respect to the valve body such that the valve portion is received in the valve accommodation hole. Further, the hydraulic control apparatus includes a fixing means, which fixes the solenoid valve to the valve body. In the hydraulic control apparatus, the spool is formed so as to slidably fit in the valve accommodation hole. The solenoid portion is disposed at an open end of the valve accommodation hole, and the solenoid portion is fixed to the valve body by fixing means.

A hydraulic control apparatus according to the invention is preferably employed in a hydraulic control system of a vehicular automatic transmission that is shifted up or down by means of hydraulic actuators or the like. For instance, plural solenoid valves are mounted in a valve body. The invention may also be applied to various types of hydraulic control apparatuses, including other hydraulic control apparatus for vehicles or hydraulic control apparatuses used in applications other than vehicles.

Examples of the solenoid valve used in the hydraulic control apparatuses according to the first aspect of the invention include a switch valve that switches a hydraulic circuit by reciprocating the spool in the axial direction, and a pressure regulating valve that controls the hydraulic pressure by urging the spool with suitable electromagnetic force, or the like. The valve body is provided with oil passages that are open in the valve accommodation hole.

The solenoid portion of the solenoid valve is mainly constituted by the plunger that abuts against the spool, and the solenoid. The solenoid is energized or excited through on-off control or duty control of exciting current, thereby to generate suitable electromagnetic force and drive the plunger.

The valve accommodation hole, in which the spool is slidably fitted, is closed at one end thereof remote from the opening portion in which the solenoid portion is fixed. For example, the valve accommodation hole is provided by forming a through-hole and screwing a male screw into a bottom portion thereof. The male screw functions as a spring retainer for a spring, such as a return spring, urging the spool. In addition, a load (urging force) of the spring can be adjusted by changing the dimension of the screw located in the valve body. Also, in the case where the diameter of the spool is constant, or the spool diameter decreases toward the solenoid portion, the mail screw may be removed so as to remove the spool from the side opposite to the solenoid portion and replace it by a new one.

For example, the snap-fastener is preferably used as the fixing device. However, other detachable fixing devices, such as screw fasteners including bolts and nuts, may be adopted. In other aspects of the invention, the solenoid portion can be fixed using an non-detachable fixing device, such as caulking, press-fitting and rivet.

The fitting projecting portion may be provided in the solenoid portion, and the fitting recessed portion may be provided in the valve portion. Alternatively, the fitting projecting portion may be provided in the valve body, and the fitting recessed portion may be provided in the solenoid portion. A plurality of pairs of fitting projecting portions and fitting recessed portions may be provided for positioning the solenoid portion and the valve accommodation hole. However, it is preferable to adapt a pair of the annular fitting projecting portion and the annular fitting recessed portion formed concentrically with the solenoid portion and the valve accommodation hole, as in the third embodiment. The valve accommodation hole itself can be also used as the fitting recessed

The fitting projecting portion and the fitting recessed portion may be used for the sole purpose of positioning the solenoid portion and the valve body. However, the fitting projecting portion may be press-fitted into the fitting recessed portion so as to fix the solenoid portion and the valve body to each other. In this case, the fitting projecting portion and the fitting recessed portion function as the fixing device.

The positioning large-diameter is provided radially inwardly of the fitting portion of the fitting projecting portion and the fitting recessed portion. However, in other embodiments of the invention, the spool may be provided with the positioning large-diameter portion that is slidably fitted in the valve accommodation hole in the vicinity of the opening portion of the valve accommodation hole, irrespective of the position or the presence of the fitting portion of the fitting projecting portion and the fitting recessed portion. In this case, the spool is positioned concentrically with the valve accommodation hole with a high accuracy at a portion that is the closest to the solenoid portion, thus assuring accommodation quality of the solenoid.

For example, the flange is formed integrally with the core a part of which protrudes from a distal end of the solenoid portion, such that the flange extends in a plate-like shape in a direction perpendicular to the axis. The flange is brought into close contact with the valve body so as to close an opening of the part accommodation hole. However, various forms of flanges, such as a flange that engages with an assembly part partially projecting from the part accommodation hole for prevention of detachment of the assembly part, may also be employed. Examples of the assembly part may include detecting devices, such as a hydraulic sensor for detecting the hydraulic pressure, a hydraulic switch, and an oil temperature sensor for detecting the oil temperature.

The snap-fastener may be formed by, for example, bending a spring sheet material made of a metal. However, the snap-fastener can be integrally molded by a synthetic resin having a certain strength.

### BRIEF DESCRIPTION OF THE DRAWINGS

The foregoing and further objects, features and advantages of the invention will become apparent from the following description of preferred embodiments with reference to the accompanying drawings, wherein like numerals are used to like elements and wherein:

FIG. 1A to FIG. 1C are views showing a hydraulic control apparatus according to a first embodiment of the invention, of which FIG. 1A is a plan view, FIG. 1B is a B-B sectional view of FIG. 1A, and FIG. 1C is a right-hand side view;

FIG. 2A to FIG. 2C are views showing another embodiment of the invention, of which FIG. 2A is a plan sectional view showing an A-A cross section of FIG. 2B, FIG. 2B is a front view, and FIG. 2C is a right-hand side view;

FIG. 3A to FIG. 3C are views showing a still another embodiment of the invention, of which FIG. 3A is a partial plan view, FIG. 3B is a front view, and FIG. 3C is a right-hand side view;

FIG. 4 is a sectional view showing a yet another embodiment of the invention; and

FIG. 5A and FIG. 5B are views showing a further embodiment of the invention, of which FIG. 5A is a partial plan view, and FIG. 5B is a front view.

### DETAILED DESCRIPTION OF THE PREFERRED EMBODIMENTS

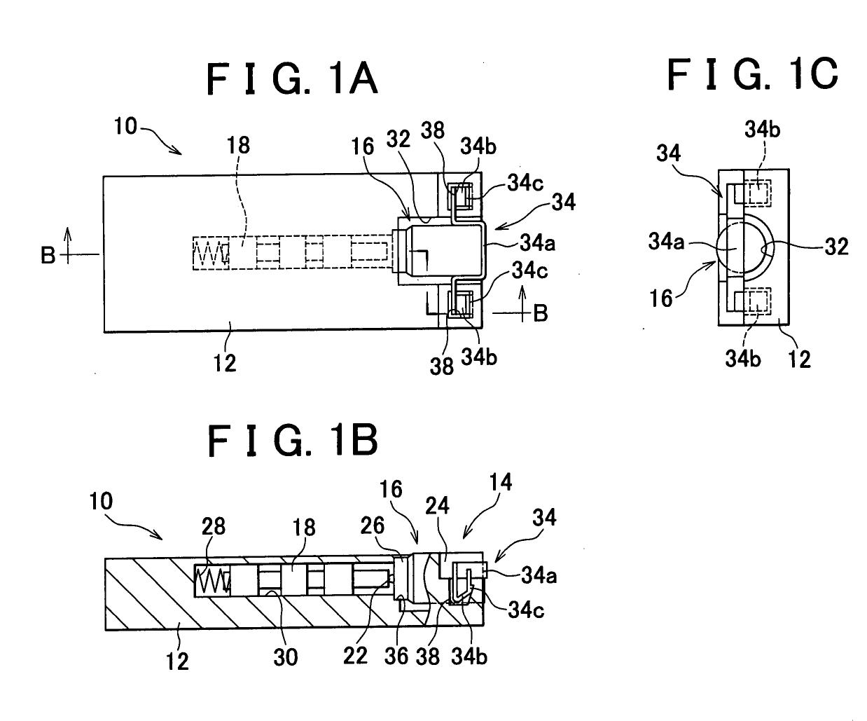

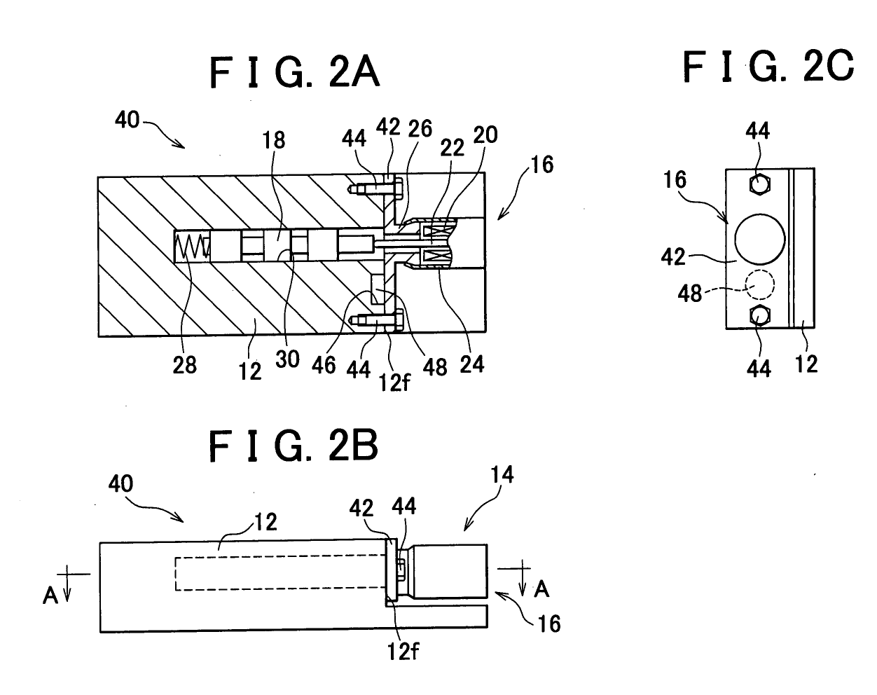

Hereafter, referring to the drawings, some embodiments of the invention will be explained in detail. FIG. 1A to FIG. 1C show a hydraulic control apparatus 10 to which the invention is applied. FIG. 1A is a plan view, FIG. 1B is a B-B sectional view, and FIG. 1C is a right-hand side view. The hydraulic control apparatus 10 is a part of a hydraulic control system of a vehicular automatic transmission. In a valve body 12 provided with oil passages that are not shown, a solenoid valve 14 is fixedly disposed. The solenoid valve 14 is a pressure adjusting valve that controls hydraulic pressure by urging a spool 18 in the axial direction through a solenoid portion 16. The solenoid portion 16, which is provided with a solenoid 20, a plunger 22, a yoke 24 and a core 26 as shown in FIG. 2A, drives the plunger 22 with a suitable electromagnetic force through duty control of exciting current of the solenoid 20, and urges the spool 18 in the left direction in FIG. 1B against urging force of a spring 28.

The valve body 12 is provided with a valve accommodation hole 30 that is closed at one end. The spool 18 constructed independently of the solenoid portion 16 is slidably fitted in the valve accommodation hole 30 in a state where the spool 18 directly contacts an inner circumferential surface of the valve accommodation hole 30. Further, the spool 18 abuts against the plunger 22 under the urging force of the spring 28. The valve on hole 30 also serves as a sleeve of the spool 18, and a valve portion of the solenoid valve 14 includes the spool 18 and the like.

Further, the valve body 12 has, at an opening side of the valve accommodation hole 30, a concave portion 32 in which the solenoid portion 16 is disposed. The solenoid portion 16 is disposed concentrically with the valve accommodation hole 30, and is detachably fixed to the valve body 12 with a snap-fastener 34. In an opening portion of the valve accommodation hole 30, a counterbore 36 corresponding to the annular core 26 is provided. The solenoid portion 16 is positioned concentrically with the valve accommodation hole 30 by fitting the core 26 into the counterbore 36. The core 26 and the counterbore 36 that engage with each other correspond to an annular fitting projecting portion and an annular fitting recessed portion, respectively.

The snap-fastener 34 functions as the fitting device to detachably fix the solenoid portion 16 to the valve body 12, and is formed by bending a spring sheet material made of metal. The snap-fastener 34 is provided with a solenoid side engaging portion 34a whose central portion is curved in an inverted C shape along a rear end portion of the solenoid portion 16, a pair of elastic deformable portions 34b that are provided continuously from the solenoid-side engaging portion 34a and a body-side engaging portion 34c. The elastic deformable portion 34b extends downward and is bent in a U-shape, such that the elastic deformable portion 34b is elastically deformed with its U-shape compressed by being inserted into an engaging hole 38 provided in the valve body 12. In this state, because the body-side engaging portion 34c is engaged with a step of the engaging hole 38, the elastic deformable portion 34b is prohibited from being pulled out of the engaging hole 38. In addition, the solenoid portion 16, which is urged in the left direction in FIG. 1A and FIG. 1B by elasticity of the elastic deformable portion 34b, is fixed to the valve body 12. The body-side engaging portion 34c engages with the step of the engaging hole 38 due to elasticity of the elastic deformable portion 34b, and therefore the solenoid portion 16 can be fixed with one-touch attachment only by inserting the elastic deformable portion 34b into the engaging hole 38. In addition, the body-side engaging portion 34c can be detached from the engaging hole 38, and the solenoid portion 16 can be removed from the valve body 12 just by pressing the end portion with a tool and the like such that the body-side engaging portion 34c is detached from the step of the engaging hole 38.

In the hydraulic control apparatus 10 as described above, the valve accommodation hole 30 of the valve body 12 also serves as the sleeve, and the spool 18 is fitted into the valve accommodation hole 30. Therefore the size of the valve accommodation hole 30 is reduced by an amount corresponding to the thickness of the sleeve, enabling the weight and size of the valve body 12 and, further the hydraulic control apparatus 10, to be reduced.

Also, the solenoid portion 16 of the solenoid valve 14 and the spool 18 are independently disposed in the valve body 12, and the solenoid portion 16 is detachably fixed to the valve body 12 with the snap-fastener 34. Therefore, in the case of a failure of the solenoid valve 14, only one of the solenoid portion 16 and the spool 18 can be easily replaced depending upon the type of the failure by releasing the engagement with the snap-fastener 34, which enables the effective use of usable resources and reduces a cost of parts.

Also, the counterbore 36 is provided at the opening portion of the valve accommodation hole 30 of the valve body 12. By fitting the core 26 of the solenoid portion 16 into the counterbore 36, both are concentrically positioned. Accordingly, variations in the quality (controlling accuracy and the like) of the solenoid valve 14 are reduced, thus assuring high quality.

Also, the snap-fastener 34 is used as the fixing device to fix the solenoid portion 16 in the valve body 12. This facilitates easy and quick assembly and replacement or the like of the solenoid portion 10.

Next, other embodiments of the invention will be explained. In the embodiments hereinafter referred to, the same reference numerals will be used for elements substantially common to the aforementioned embodiment and detailed explanation thereof will be omitted.

In a hydraulic control apparatus 40 shown in FIG. 2A to FIG. 2C, a plate-like flange 42 extending in the direction perpendicular to the axis of the solenoid portion 16 is formed integrally with the core 26 protruding toward the distal end of the solenoid portion 16. In a state where the flange 42 is in close contact with an end face 12f of the valve body 12, the solenoid portion 16 is detachably fixed to the valve body 12 with a pair of bolts 44 that function as the fixing device. Also, in the end face 12f, a part accommodation hole 46 is provided independently of the valve accommodation hole 30, and a hydraulic switch 48 as an assembly part is disposed in the part accommodation hole 46. In addition, an opening of the part accommodation hole 46 is closed by the flange 42. Accordingly, the hydraulic switch 48 can be retained in the part accommodation hole 46. Note that FIG. 2A is a plan sectional view showing an A-A cross section of FIG. 2B, FIG. 2B is a front view, and FIG. 2C is a right-hand side view.

In the hydraulic control apparatus 40 as defined above, too, the valve accommodation hole 30 of the valve body 12 also serves as the sleeve, and the spool 18 is fitted in the valve accommodation hole 30. Therefore, the size of the valve accommodation hole 30 is reduced by an amount corresponding to the thickness of the sleeve, resulting in a reduction in the weight and size of the valve body 12 and further the hydraulic control apparatus 10.

Also, the solenoid portion 16 of the solenoid valve 14 and the spool 18 are independently disposed in the valve body 12, and the solenoid portion 16 is detachably fixed to the valve body 12 with the bolts 44. Therefore, in the case of the failure of the solenoid valve 14, only one of the solenoid portion 16 and the spool 18 can be replaced depending upon the type of the failure by canceling fixation with the bolts 44, which enables the effective use of usable resources and reduces a cost of parts.

Meanwhile, in the embodiment, the part accommodation hole 46 is provided in the valve body 12, and the hydraulic switch 48 is disposed in the part accommodation hole 46. The hydraulic switch 48 is retained in the part accommodation hole 46 with the flange 42 provided in the solenoid portion 16. Therefore, assembly is conducted easily, compared to fixing the hydraulic switch 48 to the valve body 12 independently of the solenoid portion 16. In addition, the space for fixing is not required, and the solenoid valve 14 and the hydraulic switch 48 are disposed close to each other, thus reducing the size of the hydraulic control apparatus 40.

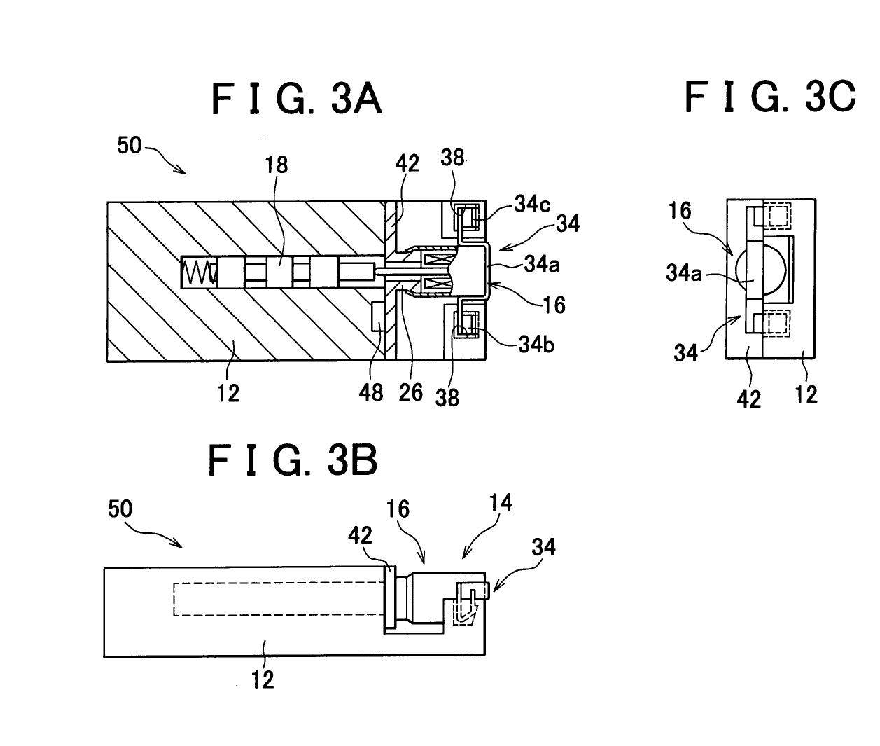

In a hydraulic control apparatus 50 shown in FIG. 3A to FIG. 3C, the solenoid portion 16 is detachably fixed to the valve body 12 with the snap-fastener 34 in place of the bolts 44 of the hydraulic control apparatus 40 shown in FIG. 2A to FIG. 2C. This permits easy and quick assembly and replacement or the like of the solenoid portion 16 and the hydraulic switch 48.

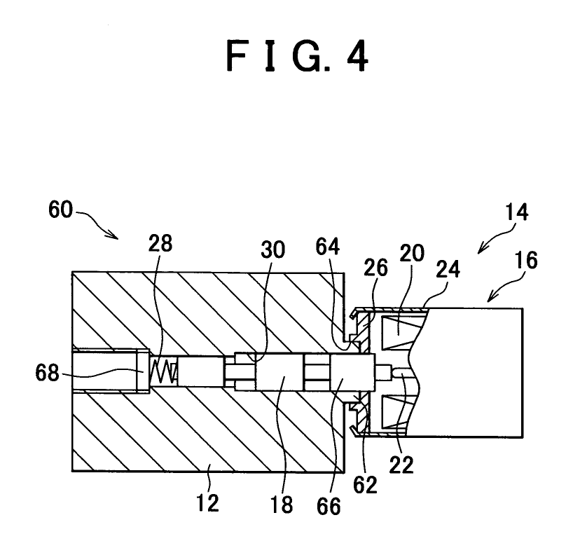

In a hydraulic control apparatus 60 shown in FIG. 4, while an annular fitting projecting portion 62 is concentrically provided at an opening portion of the valve accommodation hole 30, an annular fitting recessed portion 64 is concentrically provided at an end portion of the core 26 of the solenoid portion 16. By press-fitting the fitting recessed portion 64 on the fitting projecting portion 62, the solenoid portion 16 is fixed to the valve body 12, to be positioned concentrically with the valve accommodation hole 30. The fitting projecting portion 62 and the fitting recessed portion 64 also function as the fixing device.

Also, the spool 18 has a positioning large-diameter portion 66 provided in an inner side of a fitting portion of the fitting projecting portion 62 and the fitting recessed portion 64, that is, in the vicinity of the opening portion of the valve accommodation hole 30. With the positioning large-diameter portion 66 slidably fitted into the valve accommodation hole 30, the spool 18 is positioned concentrically with the valve accommodation hole 30 at a position that is the closest to the solenoid portion 16.

Also, the valve accommodation hole 30 is closed at one end. The bottom of the hole 30 is provided by screwing a male screw 68 into a bottom portion of a through-hole formed through the valve body 12. The initial load (urging force) of the spring 28 can be adjusted by changing the dimension of the screw 68 located in the hole 30. Also, a lock screw may be provided as required. Also, in the case where the diameter of the spool 18 is constant, or the spool diameter decreases toward the solenoid portion 16, the mail screw 68 may be moved so as to remove the spool 18 from the side opposite to the solenoid portion 16 and replace it by a new one.

In a hydraulic control apparatus 60 as described above, the valve accommodation hole 30 of the valve body 12 also serves as the sleeve, and the spool 18 is fitted in the valve accommodation hole 30. Therefore, the size of the valve accommodation hole 30 is reduced by an amount corresponding to the thickness of the sleeve, thus reducing the weight and size of the valve body 12 and, further the hydraulic control apparatus 60.

Also, the fitting projecting portion 62 is provided in the opening portion of the valve accommodation hole 30 of the valve body 12. Since the fitting projecting portion 62 is fitted into the fitting recessed portion 64 provided at the end of the solenoid portion 16, both are concentrically positioned. Therefore, the solenoid portion 16 can be fixed to the valve body 12 with a high accuracy of position. In addition, variations in the quality (controlling accuracy and the like) of the solenoid valve 14 are reduced, thus assuring high quality. Particularly in the embodiment, the spool 18 has the positioning large diameter portion 66 located radially inwardly of the fitting portion of the fitting projecting portion 62 and the fitting recessed portion 64, i.e., in the vicinity of the opening portion of the valve accommodation hole 30. The large diameter portion 66 is slidably fitted into the valve accommodation hole 30 and positioned. Accordingly, the spool 18 and the solenoid portion 16 are concentrically positioned with a high accuracy, which further improves the quality of the solenoid valve 14.

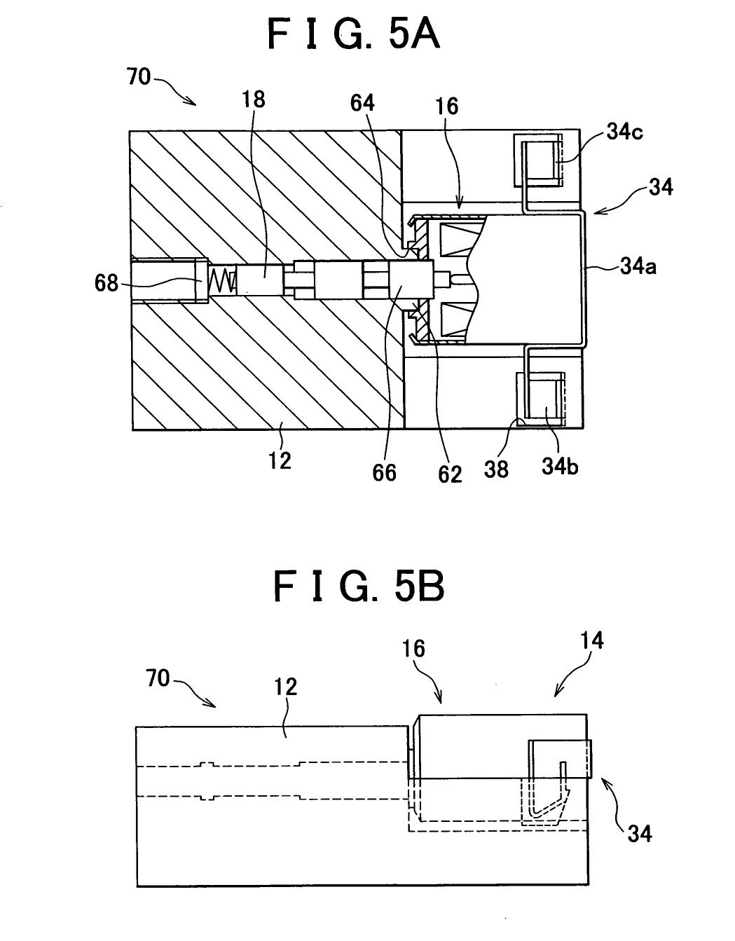

In a hydraulic control apparatus 70 shown in FIG. 5A and FIG. 5B, the fitting projecting portion 62 and the fitting recessed portion 64 in the hydraulic control apparatus 60 shown in FIG. 4A and FIG. 4B merely have a function of positioning the solenoid portion 16 concentrically, but do not have a function of fixing it to the valve body 12. Instead, the solenoid portion 16 is detachably fixed to the valve body 12 using the snap-fastener 34, permitting easy and quick assembly and replacement or the like of the solenoid portion 16. Also, in the case of a failure of the solenoid valve 14, only one of the solenoid portion 16 and the spool 18 can be easily replaced depending upon the type of the failure by canceling fixation with the snap-fastener 34, which enables the effective use of usable resources and reduces a cost of parts.

While the embodiments of the invention have been explained in detail referring to the drawings, these are only exemplary, and the invention may be carried out with various changes and modifications based on the knowledge of those skilled in the art.

What is claimed is:

1. A hydraulic control apparatus comprising:
a solenoid valve including a valve portion and a solenoid portion, wherein the valve portion has a spool, and the solenoid portion is adapted to urge the spool in an axial direction by using electromagnetic force;
a valve body having a valve accommodation hole, the solenoid valve is arranged with respect to the valve body such that the valve portion is received in the valve accommodation hole; and
a fixing member which fixes the solenoid valve to the valve body,
wherein the spool is formed so as to slidably fit in the valve accommodation hole, and the solenoid portion is disposed at an open end of the valve accommodation hole.

2. The hydraulic control apparatus according to claim 1, wherein:
the solenoid portion includes a plunger formed separately from the spool, and urges the spool by using the plunger, and
the fixing member detachably fixes the solenoid portion to the valve body.

3. The hydraulic control apparatus according to claim 1, further comprising:
a fitting projecting portion provided in one of the solenoid portion and the valve body; and
a fitting recessed portion provided in the other of the solenoid portion and the valve body,
wherein the fitting projecting portion and the fitting recessed portion engage with each other such that the solenoid portion and the valve accommodation hole are positioned concentrically with each other.

4. The hydraulic control according to claim 3, wherein:
the fitting projecting portion having an annular shape is provided concentrically in the opening portion of the valve accommodation hole, and is fitted in the fitting recessed portion having an annular shape and provided concentrically in an end portion of the solenoid portion, so as to position the valve accommodation hole and the solenoid portion concentrically with each other; and
the spool includes a positioning large-diameter portion that is located radially inwardly of a fitting portion of the fitting projecting portion and the fitting recessed portion, and the positioning large-diameter portion is slidably fitted in the valve accommodation hole, and is positioned concentrically with the valve accommodation hole.

5. The hydraulic control apparatus according to claim 4, wherein the positioning large-diameter portion is slidably fitted in the vicinity of the opening portion of the valve accommodation hole so as to position the spool concentrically with the valve hole at a position that is the close to the solenoid portion.

6. The hydraulic control apparatus according to claim 1, wherein the fitting projecting portion is press-fitted in the fitting recessed portion so that the solenoid portion is fixed to the valve body.

7. The hydraulic control apparatus according to claim 1, wherein:
the valve body has a part accommodation hole formed separately from the valve accommodation hole, the part accommodation hole receives an assembly part; and
the solenoid portion is formed integrally with a flange that engages with the assembly part thereby to prevent the assembly part from being detached from the part accommodation hole.

8. The hydraulic control apparatus according to claim 1, wherein the valve accommodation hole provided in the valve body is closed at one end thereof remote from the opening portion in which the solenoid portion is provided, and a bottom of the valve accommodation hole at the one end is provided by a male screw received in the valve body.

9. The hydraulic control apparatus according to claim 1, wherein a diameter of the spool is constant, or decreases toward the solenoid portion.

10. The hydraulic control apparatus according to claim 1, wherein:
the fixing member comprises a snap-fastener including a body-side engaging portion that engages with the valve body, a solenoid-side engaging portion that engages with the solenoid portion, and an elastic deformable portion provided between the solenoid-side engaging portion and the body-side engaging portion, the elastic deformable portion being elastically deformed while the fixing member is mounted in place in the valve body, and
the snap-fastener presses the solenoid portion against the valve body by using elasticity of the elastically deformable portion.

11. The hydraulic control apparatus according to claim 1, wherein the fixing member comprises a threaded fastening member that detachably fixes the solenoid portion to the valve body.

12. A hydraulic control apparatus comprising:
a solenoid valve including a valve portion and a solenoid portion, when the valve portion has a spool, and the solenoid portion is adapted to urge the spool in an axial direction by using electromagnetic force;
a valve body having a valve accommodation hole, the solenoid valve is arranged with respect to the valve body such that the valve portion is received in the valve accommodation hole; and
a fixing means which fixes the solenoid valve to the valve body,
wherein the spool is formed so as to slidably fit in the valve accommodation hole, and the solenoid portion is disposed at an open end of the valve accommodation hole.
